(19) United States
(12) Patent Application Publication
(10) Pub. No.: US 2014/0257916 A1
(43) Pub. Date: Sep. 11, 2014

(54) EMBROIDERY DESIGN PRODUCTION MANAGEMENT APPARATUS AND METHOD

(71) Applicant: Sunstar Co., Ltd., Incheon (KR)

(72) Inventor: In Chul Park, Seoul (KR)

(21) Appl. No.: 14/352,572

(22) PCT Filed: Oct. 17, 2012
(86) PCT No.: PCT/KR2012/008472

§ 371 Date: Apr. 17, 2014

(30) Foreign Application Priority Data
Oct. 18, 2011 (KR) 10-2011-0106527
Apr. 17, 2012 (KR) 10-2012-39897

(51) Int. Cl. G06Q 10/06

(52) U.S. Cl. CPC G06Q 10/0633
USPC 705/7.27

(57) ABSTRACT

Provided is an embroidery design production management apparatus that enables a producer to predict a delivery schedule for an order quantity for checking whether it is possible to obtain the production order of an order placer and produce and manage the ordered embroidery designs according to the order schedule of the order placer, in producing embroidery designs.

### TECHNICAL FIELD

The present disclosure relates to producing embroidery designs, and more particularly, to an embroidery design production management apparatus and method that enable a producer to predict a delivery schedule for an order quantity for checking whether it is possible to obtain the production order of an order placer and produce and manage the ordered embroidery designs according to the order schedule of the order placer, in producing embroidery designs.

### BACKGROUND ART

With an increased need for mass production and mass consumption, manufacturing companies are likely to produce products on a sublet production basis rather than on a self-production basis. In manufacturing products on a self-production basis, a single manufacturing company performs all tasks including developing, designing, manufacturing, process-managing, maintaining, and repairing of products. According to the sublet based manufacturing, an order placer, which is a company that desires to sell products at a market, places its order for manufacturing of specific products, and a product producer, which is a company that obtains relevant production equipment for manufacturing, subsequently manufactures the specific products according to the placed order.

In the sublet based manufacturing, however, a competition between producers for obtaining a production order is intense, and thus, it is important to quickly and accurately determine whether it is possible to accept the production order. That is, it is important to predict a delivery schedule for supplying the quantity of products, ordered by an order placer, based on the productive capacity of a producer, and establish an efficient production plan based on the predicted delivery schedule.

### DISCLOSURE OF INVENTION

### Technical Problem

To date, however, in embroidery design production for embroidering various patterns, pictures, and letters on cloth by using an embroider machine, whether it is possible to obtain a production order is determined depending on only the experience of a producer. That is, embroidery design producers predict a delivery schedule for an order quantity based on the past experience without analyzing in detail a self-productive capacity, and determine whether it is possible to obtain a production order. Such method is efficiently applied when a process of producing embroidery designs is simple, but, when the process of producing embroidery designs is complicated, the method is inadequate to predict a delivery schedule. For this reason, a producer may obtain a production order in a state in which the producer cannot accurately predict a delivery schedule, namely, the production order is out of the productive capacity of the producer, in which case the producer inefficiently manages an embroidery machine and users for confidently processing the request of an order placer, causing the increase in the manufacturing cost.

There are no apparatus and method for accurately predicting a delivery schedule for an order quantity in association with the embroidery design production. However, in fields (for example, a semiconductor field) other than the embroidery design production, various technologies for predicting and fulfilling a delivery schedule have been proposed. As an example of a conventional method and apparatus for predicting and fulfilling a delivery schedule, Korean Patent Publication No. 10-2009-0097623 discloses a system of a proactive scheduling approach using simulation. However, the system of the proactive scheduling approach using simulation disclosed in the patent document cannot be applied to the embroidery design production. That is, the conventional technology has no configuration for analyzing and performing an embroidery design, and thus, it is difficult to actively search a plurality of embroidery machines of a producer and identify embroidery machines, which are available and capable of processing the embroidery design (hereinafter referred to as an available embroidery machine). Also, it is difficult to analyze productivities by a process for a factory line that is configured by analyzing productivities by a machine for available embroidery machines and combining the available embroidery machines. Thus, it is unable to obtain the optimal process sequence for the embroidery design production. For this reason, an embroidery design producer may not be able to accurately predict a delivery schedule for an order quantity. Also, the conventional technology cannot provide an effective and quick solution to an error in an embroidery machine which occurs in producing embroidery designs, and thus, a producer may run into a problem in producing defective embroidery designs.

### Solution to Problem

The present disclosure provides some embodiments of an embroidery design production management apparatus and method that enable a producer to predict a delivery schedule for an order quantity for checking whether it is possible to obtain the production order of an order placer and produce and manage the ordered embroidery designs according to the order schedule of the order placer, in producing embroidery designs.

The present disclosure provides some embodiments of an embroidery design production management apparatus and method that manage embroidery design production which is started according to the order quantity and the order schedule of an order placer, and effectively and quickly resolve the error of an embroidery machine which occurs in producing embroidery design products, thus preventing a problem in production.

According to an aspect of the present disclosure, disclosed is an embroidery design production management apparatus, connected to a plurality of embroidery machines, which includes: an interface module configured to connect an order placer and at least one or more producer over a network; an input/output module configured to receive order information including an embroidery design from the order placer, receive a producer setting value from the producer, and output processing information for producing the embroidery design; a data storage module configured to store information input or output via the input/output module; a design analysis module configured to obtain design information and stitch information with the embroidery design; and a productivity prediction module configured to search and identify available embroidery machines among the plurality of embroidery machines based on the design information, the stitch information, and the producer setting value, and calculate machine productivity for the identified available embroidery machines and process productivity in a plurality of factory lines to predict a delivery schedule for checking whether it is possible to obtain the order information, the plurality of factory lines being configured by combining the available embroidery machines.

According to another aspect of the present disclosure, disclosed is the embroidery design production management apparatus which may further include a process processing module configured to transmit a work instruction, indicating start of the embroidery design production, to the available embroidery machine.

According to another aspect of the present disclosure, disclosed is the embroidery design production management apparatus which may further include a production management module configured to monitor a current work status in the embroidery design production in real time, manage a work schedule for the embroidery design production, and compare and analyze the predicted delivery schedule and an actual work schedule.

According to another aspect of the present disclosure, disclosed is the embroidery design production management apparatus which may further include an error management module configured to receive machine state information from the available design machine, the machine state information including an abnormal state message that indicates the available embroidery machine being in an abnormal state.

According to another aspect of the present disclosure, the error management module may transmit at least one of text data and multimedia data, which are necessary for repairing the abnormal state, to a user based on the abnormal state message.

According to another aspect of the present disclosure, the error management module may provide an A/S request message to the producer in response to a request of the user.

According to another aspect of the present disclosure, the error management module may monitor an A/S providing state based on the A/S request message.

According to another aspect of the present disclosure, the order information my include order placer information, an order quantity, and an order schedule.

According to another aspect of the present disclosure, the producer setting value may include number of breakings of a thread, a loss time when the breaking of the thread occurs, a loss time in replacing one head, other loss time, daily working hours, a work range of one head, design price, design margin, necessary working days, and the number of available embroidery machines.

According to another aspect of the present disclosure, the productivity prediction module may calculate a loss time, predicted working hours and number of production pieces, number of workable design pieces per one head, production quantities per process, necessary working days per machine, and number of necessary users per process for calculating the machine productivity and the process productivity.

According to another aspect of the present disclosure, the design information may include total number of needles of the embroidery design, an entire needle length of an upper thread, number of replacements of a bobbin, and a design size, and the stitch information may include a stitch width of the embroidery design.

According to another aspect of the present disclosure, the productivity prediction module may calculate working days necessary for a critical path in the plurality of factory lines, and calculates an estimated profit and loss and an estimate cost per unit.

According to another aspect of the present disclosure, disclosed is an embroidery design production management method which includes: receiving order information including an embroidery design from an order placer and receiving a producer setting value from a producer, over a network; analyzing the embroidery design; searching and identifying available embroidery machines among a plurality of embroidery machines connected to the network, according to the analyzed result of the embroidery design and the producer setting value; calculating machine productivity for the identified available embroidery machines and process productivity in a plurality of factory lines that are configured by combining the available embroidery machines; predicting a delivery schedule for an order quantity for the order information based on the calculated machine productivity and the calculated process productivity, and comparing the predicted delivery schedule and an order schedule for the order information; and re-searching and re-identifying the plurality of embroidery machines connected to the network and an embroidery machine, which is additionally set by the producer, until the delivery schedule satisfies the order schedule, and repeatedly performing the calculating machine productivity and process productivity for a re-identified available embroidery machine and the comparing the predicted delivery schedule and the order schedule.

According to another aspect of the present disclosure, the embroidery design production management method may further include transmitting a work instruction to the available embroidery machine to start the embroidery design production when the delivery schedule satisfies the order schedule, after the comparing the predicted delivery schedule and an order schedule.

According to another aspect of the present disclosure, the embroidery design production management method may further include: monitoring a current work status on the available embroidery machine in real time; managing a work schedule for the available embroidery machine; and comparing and analyzing the predicted delivery schedule and an actual work schedule.

According to another aspect of the present disclosure, the monitoring a current work status may include receiving a machine state information from the available embroidery machine, the machine state information including an abnormal state message that indicates the available embroidery machine being in an abnormal state.

According to another aspect of the present disclosure, the embroidery design production management method may further include transmitting at least one of text data and multimedia data, which are necessary for repairing the abnormal state, to a user based on the abnormal state message.

According to another aspect of the present disclosure, the embroidery design production management method may further include sending an A/S request message to the producer in response to a request of the user.

According to another aspect of the present disclosure, the embroidery design production management method may further include monitoring an A/S providing state for the available embroidery machine based on the A/S request message.

According to another aspect of the present disclosure, the calculating machine productivity and process productivity may include calculating a loss time, predicted working hours and number of production pieces, number of workable design pieces per one head, production quantities per process, necessary working days per machine, and number of necessary users per process.

According to another aspect of the present disclosure, the loss time may be calculated with the following Equation (1);

(total loss time[min]in producing one piece)=(loss time[min]in breaking of thread)+(loss time[min]in replacing bobbin)+(other loss time[min]) (1)

where(loss time[min]in breaking of thread)=(number of breakings of thread×loss time[sec]when breaking of thread occurs)/60,(loss time[min]in replacing bobbin)=(number of replacements of bobbin×total number of heads×loss time[sec]in replacing one head)/60,(number of replacements of bobbin)=(quantity[meter]of consumed bottom thread)/100 when general shuttle,(number of replacements of bobbin)=(quantity[meter]of consumed bottom thread)/150 when large shuttle,(quantity[meter]of consumed bottom thread)=(entire needle length of upper thread)×⅔,

where the number of breakings of thread, the loss time when breaking of thread occurs, the loss time in replacing one head, the number of heads based on number of available embroidery machines, and the other loss time including a piece replacement time are input as a plurality of producer setting values, and the entire needle length of upper thread and the number of replacements of bobbin are calculated in an embroidery design analysis operation.

According to another aspect of the present disclosure, the predicted working hours and the number of production pieces may be calculated with the following Equations (2) and (3);

(predicted time[min]in producing one design)=Sum(RPM_TABLE[M][S]+RPM_TABLE[M][S]+RPM_TABLE[M][S]+ . . . ) (2)

where [M] denotes the type of an embroidery machine, [S] denotes a stitch length, and RPM_TABLE[M][S] denotes a defined time for the needle length of a selected embroidery machine,

(number[times]of production pieces per daily working hours)=(daily working hours[hour]×60 [min])/(predicted time[min]in producing one design+total loss time[min]in producing one piece) (3)

where daily working hours are input as a producer setting value, predicted time in producing one design is calculated with the Equation (2), and total loss time in producing one piece is calculated with the Equation (1).

According to another aspect of the present disclosure, the number of workable design pieces per one head may be calculated with the following Equation (4);

(number of workable design pieces per one head)=Rxcnt×Cycnt (4)

where Cycnt denotes number of embroidery designs included within a range in which a column interval between embroidery designs and upper and lower outline margins are excluded within a vertical work range, and Rxcnt denotes number of embroidery designs included within a range in which a row interval between embroidery designs and left and right outline margins are excluded within a horizontal work range.

According to another aspect of the present disclosure, the production quantities per process and necessary working days per machine may be calculated with the following Equations (5) and (6);

(production quantities per process)=(number[times]of production pieces per daily working hours)×(number[times]of workable design pieces per one head)×(number of heads)×(necessary working days by embroidery machine) (5)

(necessary working days per machine)=(production quantities per process/N)/(number[times]of production pieces per daily working hours×number of workable design pieces per one head×number of heads) (6)

where the number of production pieces per daily working hours is calculated with Equation (3), the number of workable design pieces per one head is calculated with Equation (4), the number of heads is input as a producer setting value, and N denotes the number of selected embroidery machines.

According to another aspect of the present disclosure, the number of necessary users per process may be calculated with the following Equation (7);

(number of necessary users per process)=(sum of heads per process machine/number of basic heads per user×daily working hours[hour]/(basic working hours per user) (7)

where the sum of heads per process machine is automatically calculated in selecting an embroidery machine, and the number of basic heads per user, the daily working hours, and the basic working hours per user are input as a plurality of producer setting values.

According to another aspect of the present disclosure, the calculating process productivity in a plurality of factory lines may include obtaining a critical path in the plurality of factory lines.

Hereinafter, embodiments of the present disclosure will be described in detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Like reference numerals refer to like elements throughout.

An embroidery design production management apparatus 100 according to an embodiment of the present disclosure will be described below with reference to FIGS. 1 to 13.

The embroidery design production management apparatus 100, as illustrated in FIG. 1, may be applied to an embroidery design production management system 1000. In the embroidery design production management system 1000, a plurality of producers 10 to 15 are connected to one another over a network 1, for sharing machine information of a plurality of embroidery machines 20 with a plurality of embroidery machines 25 that are owned by the producers 10 to 15 respectively. The embroidery design production management apparatuses 100 of the respective producers 10 to 15 are connected to at least one or more embroidery machines 20 and to the embroidery machines 25 of the respective producers 10 to 15 over a network 2, respectively. In the present embodiment, each of the producers 10 to 15 includes the embroidery design production management apparatus 100, and the producers 10 to 15 are connected to one another over the network 1. In another embodiment of the present disclosure, the embroidery design production management apparatus 100 may be configured with a host device, so that each of the producers 10 to 15 may be connected to the embroidery design production management apparatus 100 through their own terminal equipment depending on the case.

Each of the embroidery machines 20 to 25 may include a control box and an input/output box. The control box of each of the embroidery machines 20 to 25 may receive information and data on work instructions and cautions from the embroidery design production management apparatus 100 in association with embroidery design production. Further, the control box may set the working conditions of the embroidery machines 20 to 25 based on the received information and data. Also, a user can immediately check information and data regarding the embroidery design production in a workplace by using the input/output box of each of the embroidery machines 20 to 25. Additionally, the user may input information and data regarding a machine state and a current work status by using the input/output box, and the input information and data may be transferred to the embroidery design production management apparatus 100 via the control box.

The embroidery design production management apparatus 100, as illustrated in FIG. 2, may be connected to a plurality of order placers 30 including respective terminal equipment over the network 1, and receive order information regarding the embroidery design production. Also, the embroidery design production management apparatus 100 may transmit various processing information, which is generated in association with the embroidery design production, to the terminal equipment of the order placer 30.

In the present embodiment, at least one of a dedicated local area network (LAN), a wire area network, a public switched telephone network (PSTN), and wireless communications may be used as the network 1 that connects the embroidery design production management apparatuses 100 of the respective producers 10 to 15 and also connects the embroidery design production management apparatus 100 and the external order placer 30, and the network 2 that respectively connects the embroidery design production management apparatuses 100 of the respective producers 10 to 15 and the embroidery machines 20 to embroidery machines 25 of the respective producers 10 to 15, but the present disclosure is not limited thereto. Also, the networks 1 and 2 may be operated based on known network protocols such as TCP/IP, FTP, and HTTP, but are not limited thereto.

Referring again to FIG. 2, the embroidery design production management apparatus 100 according to an embodiment of the present invention may include a central processing module 110, an interface module 120, an input/output module 130, a data storage module 140, a design analysis module 150, and a productivity prediction module 160. Also, the embroidery design production management apparatus 100 may further include a process processing module 170, a production management module 180, and an error management module 190.

The central processing module 110 may interworking-control the other modules 120 to 190 of the embroidery design production management apparatus 100 such that the embroidery design production is smoothly performed according to a series of process sequences. The central processing module 110 may be a general computer, a computer for a special purpose, a distributed processing system, or one independent operation processing apparatus, but is not limited thereto.

The interface module is connected to the terminal equipment of the order placer 30 over the network 1, and also connected to at least one or more embroidery machines 20 of a corresponding producer 10 over the network 2. Therefore, the order placer 30 may check machine information of the embroidery machine 20 which is owned and operated by each of the producers 10 to 15. Similarly, one producer 10 may be connected to the other producers 11 to 15 over the network 1, so that the producer 10 can check machine information of the embroidery machines 21 to 25 which are owned and operated by the other producers 11 to 15 respectively. The machine information may include information such as the type of an embroidery machine, an embroidery type, an operation state, a suspension state, and a standby state. As described above, the producers 10 to 15 may share the use of the embroidery machines 20 to 25, and thus, depending on the case, the one producer 10 may use the embroidery machines 21 to 25 of the respective other producers 11 to 15.

The input/output module 130 may authenticate the order placer 30 connected thereto via the interface module 120, and the producer 10 managing the embroidery design production management apparatus 100. Also, the input/output module 130 may authenticate a user who places embroidery design products with the embroidery machine 120. The authentication procedure may be performed using inputting identifier (ID) and a password, but is not limited thereto.

The embroidery design production management apparatus 100 may receive production order information regarding the embroidery design production from the order placer 30 via the input/output module 130, and receive a producer setting value from the producer 10. Also, the embroidery design production management apparatus 100 may receive the inquiry of the order placer 30, and output a response from the producer 10 regarding the inquiry. The order information received from the order placer 30, as illustrated in FIG. 3, may be checked with an output screen 2100 using the input/output module 130, and include embroidery designs S1 to S4, order placer information 2102, an order quantity 2104, an order schedule 2106, and information 2108 of a product on which the embroidery designs S1 to S4 are embroidered. A work check window 2110, which arranges and shows the order quantity and an order schedule for the embroidery designs S1 to S4, may be output on the output screen 210 for order information by manipulating the input/output module 130 such as a click of a mouse.

The producer setting value may include the number of times the breaking of a thread occurs, a loss time when the breaking of a thread occurs, a loss time in replacing one head, any other loss time, daily working hours, a work range of one head, a design price, a design margin, necessary working days, and the number of available embroidery machines. The producer setting value indicates a value that is directly measured or checked by a user.

The input/output module 130 may include a keyboard, a mouse, a pointing device, a microphone, a joystick, and a scanner as an input means, and include a monitor display, a speaker, and a printer as an output means. However, the present disclosure is not limited thereto. Also, the input/output module 130 may be included in various portable electronic terminals connectable to the interface module 120 over the network 1. In this case, the producer 10 having the portable electronic terminal may input or output various information regarding the embroidery design production to check the various information irrespective of the time and the place.

The data storage module 140 may store an access record for the networks 1 and 2, via the interface module 120. Various information input and output via the input/output module 130 may be automatically stored in the data storage module 140, or may be stored according to a selection by the order placer 30 or the producer 10. The various information stored in the data storage module 140 may be repeatedly output via the input/output module 130. The order placer 30 or the producer 10 may change or delete the content of information within a given authorization range, in which case the changed information may be again stored in the data storage module 140.

The design analysis module 150 analyzes the embroidery designs S1 to S4 in the order information input via the input/output module 130 to obtain design information and stitch information. As illustrated in FIG. 4, the result of the embroidery design analysis may be output via the input/output module 130. Based on the result of the embroidery design analysis, an output screen 2200 may display design information 220 and stitch information 2204, and moreover display the embroidery design S1 as an image 2206. Also, the size of the embroidery design S1 may be displayed on the output screen 2200. When the embroidery designs S1 to S4 are provided in group, the analysis results of the respective embroidery designs S1 to S4 may be displayed on different output screens. The design information 2202 may include information regarding the total number of needles of a design, the entire needle length of an upper thread, the number of replacements of a bobbin, and a design size. The stitch information 2202 may include information regarding a stitch width.

The productivity prediction module 160 may search the plurality of embroidery machines 20 to 25 connected to the networks 1 and 2 to identify available embroidery machines, based on the design information 2202 and stitch information 2204 (which are obtained by the design analysis module 150) and the producer setting value input by the producer 10, and calculate machine productivity (for example, necessary working days per machine) for the identified available embroidery machines. Also, the productivity prediction module 160 may calculate process productivity, for example, production quantities per process and the number of necessary users per process, in a factory line that is configured by combining the available embroidery machines. A method of calculating machine productivity and process productivity will be described in an embroidery design production management method to be described below.

The productivity prediction module 160, as illustrated in FIG. 5, may display a layout 2302 of a factory in the form of a design piece on a process simulation output screen 2300 via the input/output module 130, by using a tool window 2304. The tool window 2304 may include a plurality of icons that enable the drawing of a line, the erasure of a line, the selection of a line type, the selection of a line color, etc. The productivity prediction module 160 may output an embroidery machine as an icon 2310 (which is moved in a drop and drag type) on the output screen 2300, and the icon 2310 may be arranged through various combinations in the layout 2303 of the factory. In the output screen 2300, the size of layout 2302 of the factory to the size of the icon 2310 of the embroidery machine may be automatically changed according to the ratio of the size of an actual factory and the size of an actual embroidery machine. Thus, the arrangement state of embroidery machines in the factory may be checked in advance. The icon 2310 of the embroidery machine may be output and displayed in different colors, if the machine state information were divided into a workable state, a working state, and other states according to output colors. Also, both an icon 2311 indicating the identification number of the embroidery machine and an icon 2312 indicating the type of the embroidery machine (for example, a many-headed type, a few-headed type, a dual type, and a single-headed type) may be displayed on the icon 2310 of the embroidery machine.

The productivity prediction module 160, as illustrated in FIG. 6, is configured to perform a process simulation on a plurality of factory lines, which are configured by virtually combining machine productivity for the available embroidery machines, and the available embroidery machines (icons of the embroidery machine). The process simulation may calculate working days that are expended from the start of work to the end of work for embroidery design production, in each of the factory lines. Especially, working days may be calculated for a critical path 2410 in the plurality of factory lines. Here, because the critical path 2410 is a process that requires the longest working days in the factory lines and the critical path 2410 may become a process that allows for no spare time in producing an embroidery design, the critical path 2410 is essentially managed by the producer 10. The producer 10 may predict a delivery schedule for supplying the order quantity based on working days that are calculated through the process simulation, and compare the predicted delivery schedule with the deadline for the actual delivery requested by the order placer 30, thereby determining whether it is possible to produce all of ordered embroidery designs by the delivery deadline.

The productivity prediction module 160, as illustrated in FIG. 7, may provide an output window 2510 enabling the calculation of an predict and a screen window 2520 displaying the cost incurred in the embroidery design production. The producer 10 may input a corresponding value via the input/output module 130 to calculate the estimated profit and loss and the estimate cost per unit.

In the present embodiment, to calculate machine productivity and process productivity, the productivity prediction module 160 may calculate a loss time, predicted working hours and number of production pieces, the number of workable design pieces per one head, production quantities per process, necessary working days per machine, and the number of necessary users per process. A method of calculating a loss time, predicted working hours and number of production pieces, the number of workable design pieces per one head, production quantities per process, necessary working days per machine, and the number of necessary users per process will be described in the embroidery design production management method to be described below.

Since the result predicted by the productivity prediction module 160 satisfies the production order condition of the order placer 30, when the producer 10 takes a placed order, the process processing module 170 starts to produce embroidery designs according to the optimal process sequence that is used for predicting a delivery schedule. To this end, when it is required to expand a productive capacity by using the respective embroidery machines 21 to 25 of the other producers 11 to 15, the process processing module 170 may show the order content to the other producers 11 to 15, and transmit respective messages, requesting the use of the embroidery machines 21 to 25, to the other producers 11 to 15. When the one producer 10 includes all embroidery machines necessary for producing embroidery designs, the process processing module 170 may not transmit a message, requesting the provision of the production order content and the use of an embroidery machine, to the other producers 11 to 15. When the process processing module 170 receives acknowledgement messages from the respective producers 11 to 15 receiving a request for the use of the embroidery machines 21 to 25, the process processing module 170 may transmit an allocated work instruction to a corresponding embroidery machine.

When at least one of the other producers 11 to 15 does not acknowledge the request for the use of the embroidery machines 21 to 25 due to a special reason, the process processing module 170 may repeatedly search and identify embroidery machines other than the embroidery machines of the producer 10 which has not acknowledged the request, such that the embroidery design production is performed according to the optimal process sequence. Also, when an embroidery machine, which is necessarily used for the embroidery design production among the embroidery machines 20 to 25 connected to the process processing module 170 over the networks 1 and 2, is not included in a search target, the process processing module 170 may add a virtual embroidery machine (for example, an embroidery machine which is being sold) into the search target according to the setting of the producer 10, and may repeatedly search and identify available embroidery machines.

The production management module 180 receives an allocated work instruction from the process processing module 170, and performs the production management of a working embroidery machine. The production management module 180, as illustrated in FIG. 8, may in real time monitor a current work status for all working embroidery machines. An output screen 3100 showing the monitoring result of a current work status displays working conditions 3106 such as a process step 3102, total working hours to a progress state 3104, images 3106 for embroidery designs, a working speed, a needle table, a current working state, an automatic thread tension setting value, productivity, the number of thread breakings, a loss time, occurrence of an error, and users, thereby enabling the producer 10 to smoothly check the embroidery design production in real time. Also, as illustrated in FIG. 9, the production management module 180 outputs a work schedule in the form of a calendar for easy management. A screen 3200, which is output to manage the work schedule, may display a schedule management window 3210 allowing the addition or change of the work schedule.

Moreover, as illustrated in FIG. 10, the production management module 180 may perform a productivity comparison analysis operation that compares a produceable quantity and schedule 3310 predicted by the productivity prediction module 160 and an actually worked quantity and schedule 3320. A productivity comparison analysis result 3330 may be output with various charts 3340. Through the productivity comparison analysis operation, the producer 10 may check whether the work is being performed according to the predicted delivery schedule, and moreover use the productivity comparison analysis result to determine whether it is possible to obtain a placed order.

The error management module 190 may receive machine state information from a working embroidery machine. The machine state information may include an abnormal state message indicating that an embroidery machine is in an abnormal state. The error management module 190 may output the current management status of embroidery machines via the input/output module 130. The output screen may include a line field displaying a factory line with embroidery machines arranged therein, a model field displaying the type of a corresponding embroidery machine, an error code field, an occurrence time field displaying a time at which an abnormal state message is generated, and a description field describing an abnormal state. Also, the output screen may include a self-repair field providing information necessary for repairing the abnormal state. When a user clicks on a self-repair field icon for a desired embroidery machine, the self-repair field may provide information, which is necessary for repairing the abnormal state, in the form of at least one of text data and multimedia data. Also, the output screen may include a current progress status field displaying an after-sales service status for an embroidery machine having an abnormal state. In the present embodiment, the current progress status field may provide whether to request an after-sales service and an after-sales service progress status according to a user clicking on an icon that indicates the current progress status of a corresponding embroidery machine, and may include an after-sales service (A/S) completion field displaying the completion of an after-sales service.

As illustrated in FIG. 11, text data 4200 may be provided to a user based on an abnormal state message transmitted by an embroidery machine. The text data 4200 may include machine information 4202 that displays the type of an embroidery machine transmitting the abnormal state message, a serial number, a control box, an error code, and a description on an abnormal state. Also, the text data 4200 may provide a search window 4250 that allows a user to input symptom-related keywords and perform a search. The text data 4200 may include a symptom display part 4204 that displays symptoms according to the input keywords, and a cause display part 4206 displaying the corresponding cause of each of the displayed symptoms. The text data 4200 shows a management method on a management method display part 4208 based on the symptom and cause of the abnormal state of the embroidery machine, and the user may apply the management method to an abnormal embroidery machine based on the text data 4200. The text data 4200 may provide a management completion button 4260 that allows the user to input the abnormal state of the embroidery machine being repaired after the management method is applied to the embroidery machine, and an A/S request button 4270 that allows the transmission of an A/S request message for an unresolved abnormal state.

As illustrated in FIG. 12, multimedia data 4300 may be provided to a user based on an abnormal state message transmitted by an embroidery machine. The multimedia data 4300 may provide information, which is necessary for repairing the abnormal state of the embroidery machine based on the abnormal state message, in the form of multimedia such as a video, a sound, photographs, and a hologram. For example, the multimedia data 4300 may show a management method of repairing the abnormal state using a photograph 4302, and include a video 4304 that describes the management method necessary for the user.

As illustrated in FIG. 13, an A/S request message 4400 from a user may be provided to the producer 10. The A/S request message 4400 may include information regarding an abnormal embroidery machine. For example, the A/S request message 4400 may include basic information 4410 such as a name of the producer 10 having a corresponding embroidery machine, a name of a user requesting an after-sales service, a model of the embroidery machine, a serial number, a control box, a number of a factory line with the embroidery machine arranged therein, and a work start date of the embroidery machine. The A/S request message 4400 may include information necessary for providing an after-sales service. For example, the A/S request message 4400 may include A/S receipt registration information 4420 such as an error code corresponding to an abnormal state, a symptom, and self-processing check content indicting a management method that is performed against the abnormal state. The A/S request message 4400 may include an A/S request button 4430 that enables the producer 10 to check content included in the message, and then finally input a transmission instruction for an A/S request provided to an A/S processing agent.

As described above, the error management module 190 may provide information for repairing a corresponding abnormal state based on the content of the abnormal state, in the form of at least one of the text data 4200 and the multimedia data 4300. A user may adjust an embroidery machine and perform any necessary management based on information provided by the text data 4200 and the multimedia data 4300, for repairing the abnormal state. When the abnormal state is continued to exist even after the adjustment or the management, the error management module 190 may provide the A/S request message 4400 to the producer 10. After the A/S request, the error management module 190 may monitor a time taken until an A/S processing agent arrives, an A/S progress status, and whether an after-sales service is completed.

Hereinafter, an embroidery design production management method according to an embodiment of the present disclosure using the above-described embroidery design production management apparatus will be described with reference to the accompanying drawings. In the below description, the same description as that of the above-described embroidery design production management apparatus is not provided or is simply made.

Referring to FIGS. 14 to 16, the embroidery design production management method according to an embodiment of the present disclosure may include: operation S100 that receives order information regarding the embroidery design production from an order placer over a network; operation S200 that analyzes an embroidery design included in the order information to obtain design information and stitch information; operation S300 that searches embroidery machines connected to the network to identify available embroidery machines based on the design information and the stitch information; operation S400 that calculates machine productivity for the identified available embroidery machines and process productivity in a plurality of factory lines that are configured by combining the available embroidery machines, and predicts a delivery schedule based on the calculated machine productivity and process productivity; operation S500 that compares the predicted delivery schedule and an order schedule; and operation S600 that adds, when the predicted delivery schedule cannot satisfy the order schedule, the embroidery machines of other producers connected to the network and a virtual embroidery machine (which is additionally set by the producer) into a search target, and re-searches and re-identifies workable available embroidery machines necessary for the embroidery design production. Also, the embroidery design production management method according to an embodiment of the present disclosure may repeatedly perform operation S400 that calculates machine productivity and process productivity for the re-identified available embroidery machines, and operation S500 that compares the newly predicted delivery schedule and the order schedule.

Moreover, the embroidery design production management method according to an embodiment of the present disclosure may further include: operation S700 that starts to produce a plurality of the embroidery designs according to the optimal process sequence applied to the predicted delivery schedule, when the predicted delivery schedule satisfies the order schedule based on the compared result; operation S800 that performs production management simultaneously with the start of the embroidery design production; and error management operation S900 that resolves the error of an embroidery machine which accidentally occurs in the embroidery design production operation.

Operation S100 of receiving the order information from the order placer may include an operation that stores the order information input from the order placer. Also, operation 100 may include an operation that receives a producer setting value from a producer and stores the received producer setting value. When there is no change in the embroidery machine of the producer or a user, the producer may apply a producer setting value (which is first input and stored) to a subsequent embroidery design production process without repeatedly inputting the producer setting value.

Operation of analyzing the embroidery design may include operation S210 that loads the stored order information, and operation S220 that analyzes the embroidery design included in the order information to obtain the analyzed result of the design information and stitch information. Here, the design information may include the total number of needles of a design, the entire needle length of an upper thread, the number of replacements of a bobbin, and a design size. The stitch information may include the stitch width of the embroidery design. Also, operation S200 may include operation S230 that checks, after operation S220 of obtaining the analyzed result of the embroidery design, whether a stitch type is a normal stitch or a sequin stitch, checks the distribution of stitches to determine an appropriate working speed, and determines workable embroidery machines based on design size information.

After the analysis of the embroidery design is completed, the embroidery design production management method according to an embodiment of the present disclosure performs operation S300 that searches and identifies available embroidery machines connected to the network. Operation S300 may include: operation S310 that generates a machine list of embroidery machines connected to the network; operation S320 that analyzes the machine list including machine information; operation S330 that determines embroidery machines, which are workable currently and are not limited in design size, in the embroidery machine list, and determines and identifies available embroidery machines which are capable of performing work according to whether to use option devices, such as sequins and spangles, based on the design information; and operation S340 that finally defines a machine list of workable available embroidery machines. To determine available embroidery machines, embroidery machines that are included a producer may be first searched, and embroidery machines that other producers connected to a network may be searched thereafter. Also, when embroidery machines necessary for embroidery design production are not searched, the embroidery design production management method according to an embodiment of the present disclosure may third add a virtual embroidery machine (purchasable or rentable embroidery machine), which is set by the producer, into a search target, and perform a research.

Operation S400 calculates machine productivity for the embroidery machines defined in the machine list and process productivity in a plurality of factory lines that are configured by combining the embroidery machines. Further, Operation S400 may calculate a loss time, predicted working hours and number of production pieces, the number of workable design pieces per one head, production quantities per process, necessary working days per machine, and the number of necessary users per process.

A loss time may be calculated with the following Equation (1).

(total loss time[min]in producing one piece)=(loss time[min]in breaking of thread)+(loss time[min]in replacing bobbin)+(other loss time[min]) (1)

where the loss time when breaking of thread occurs and the loss time in replacing bobbin may be calculated with the following Equations (1-1) to (1-5).

(loss time[min]in breaking of thread)=(number of breakings of thread×loss time[sec]when breaking of thread occurs)/60 (1-1)

(loss time[min]in replacing bobbin)=(number of replacements of bobbin×total number of heads×loss time[sec]in replacing one head)/60 (1-2)

when general shuttle,(number of replacements of bobbin)=(quantity[meter]of consumed bottom thread)/100 (1-3)

when large shuttle,(number of replacements of bobbin)=(quantity[meter]of consumed bottom thread)/150 (1-4)

(quantity[meter]of consumed bottom thread)=(entire needle length of upper thread)×⅔ (1-5)

where the number of breakings of thread, the loss time when breaking of thread occurs, the loss time in replacing one head, the number of heads based on number of available embroidery machines, and the other loss time including a piece replacement time are input as a plurality of producer setting values, and the entire needle length of upper thread and the number of replacements of bobbin are calculated in an embroidery design analysis operation.

Predicted working hours and the number of production pieces may be calculated with the following Equations (2) and (3).

(predicted time[min]in producing one design)=Sum(RPM_TABLE[M][S]+RPM_TABLE[M][S]+RPM_TABLE[M][S]+) (2)

where [M] denotes the type of an embroidery machine, [S] denotes a stitch length, and RPM_TABLE[M][S] denotes a defined time for the needle length of a selected embroidery machine.

(number[times]of production pieces per daily working hours)=(daily working hours[hour]×60 [min])/(predicted time[min]in producing one design+total loss time[min]in producing one piece) (3)

where daily working hours are input as a producer setting value, predicted time in producing one design is calculated with Equation (2), and total loss time in producing one piece is calculated with Equation (1).

The number of workable design pieces per one head may be calculated with the following Equation (4).

(number of workable design pieces per one head)=Rxcnt×Cycnt (4)

where, as illustrated in FIG. 6, Cycnt denotes number of embroidery designs included within a range in which a column interval (Cy) between embroidery designs and upper and lower outline margins (Om) are excluded within a vertical work range (Y work range), and Rxcnt denotes number of embroidery designs included within a range in which a row interval (Rx) between embroidery designs and left and right outline margins (Om) are excluded within a horizontal work range (X work range). The column interval (Cy) between the embroidery designs, the row interval (Rx) between the embroidery designs, and the outline margins (Om) are set by a producer.

Production quantities per process and necessary working days per machine may be calculated with the following Equations (5) and (6).

(production quantities per process)=(number[times]of production pieces per daily working hours)×(number[times]of workable design pieces per one head)×(number of heads)×(necessary working days by embroidery machine) (5)

(necessary working days per machine)=(production quantities per process/N)/(number[times]of production pieces per daily working hours×number of workable design pieces per one head×number of heads) (6)

where the number of production pieces per daily working hours is calculated with Equation (3), the number of workable design pieces per one head is calculated with Equation (4), the number of heads is input as a producer setting value, and N denotes the number of selected embroidery machines.

The number of necessary users per process may be calculated with the following Equation (7).

(number of necessary users per process)=(sum of heads per process machine/number of basic heads per user×daily working hours[hour]/(basic working hours per user) (7)

where the sum of heads per process machine is automatically calculated in selecting an embroidery machine, and the number of basic heads per user, the daily working hours, and the basic working hours per user are input as a plurality of producer setting values.

Operation S400, which calculates machine productivity and process productivity, may predict working days for the critical path, having the longest working days in a plurality of factory lines, as a delivery schedule for the order quantity. Also, operation S400 may calculate the estimated profit and loss and the estimate cost per unit for the embroidery design production by calculating productivity.

The predicted delivery schedule is a prediction result value that allows for the production of ordered embroidery designs based on the productive capacity of a producer. Operation S500, which compares the delivery schedule and the order schedule, is performed in order for the producer to determine whether it is possible to obtain a placed order. The comparison of the delivery schedule and the order schedule may be repeatedly performed until the delivery schedule satisfies the order schedule.

When it is determined through the comparison of the delivery schedule and the order schedule that it is possible to obtain the placed order, the embroidery design production may be started. Operation S700, which starts the embroidery design production, performs the production according to the optimal process sequence that has been set for predicting the delivery schedule. When an embroidery machine included in a factory line for predicting the delivery schedule is an embroidery machine that is included in the other producer, operation S700 may include operation S710 that requests the use of the embroidery machine from the other producer, operation S720 that transmits an allocated work instruction to the embroidery machine after the requested use of the embroidery machine is approved.

After the embroidery design production is performed, the production management operation S800 for enhancing productivity is performed. Such production management operation S800 may include operation S810 that monitors a current work status in the embroidery design production in real time, operation S820 that manages a work schedule for an embroidery machine or a user, and operation S830 that compares and analyzes productivities based on the predicted delivery schedule and an actual work schedule.

Operation S812, which checks whether an error occurs in the embroidery machine in performing the embroidery design production, may be performed after operation S810 that monitors the current work status in embroidery design production, or may be performed simultaneously with monitoring operation S810. Also, the embroidery design production management method according to an embodiment of the present disclosure may include operation S900 that performs error management so as to resolve the error which occurs in the embroidery machine in performing the embroidery design production. As illustrated in FIG. 15, operation S900 of performing error management may include: operation S910 that receives machine state information from a working embroidery machine; operation S920 that checks whether an abnormal state message is included in the machine state information; operation S903 that provides, when the abnormal state message is included in the machine state information, at least one of text data and multimedia data to a user, and performs adjustment or management on the embroidery machine; and operation S940 that performs adjustment or management on the embroidery machine with the text data or multimedia data, provided for repairing the abnormal state, to determine whether the abnormal state has been repaired based on the abnormal state message. When it is determined in operation S940 that the abnormal state is not repaired in spite of the adjustment by the producer, operation S900 proceeds to operation S950 of requesting an after-sales service from the producer. When the abnormal state is repaired after the after-sales service is provided, operation S900 returns to operation S960 of receiving new machine state information. After the after-sales service is requested, an operation of monitoring the progress of the after-sales service may be performed until the after-sales service is completed.

While certain embodiments have been described, these embodiments have been presented by way of example only, and are not intended to limit the scope of the disclosures. Indeed, the novel methods and apparatuses described herein may be embodied in a variety of other forms; furthermore, various changes, modifications, correactions, and substitutions with regard to the embodiments described herein may be made without departing from the spirit of the disclosures. Also, the elements and operations of the sewing design manufacturing management apparatus and method of the present disclosure may be implemented as a plurality of distributed hardware modules or software modules.

Therefore, the accompanying claims and their equivalents including the foregoing modifications are intended to cover the scope and spirit of the disclosures, and are not limited by the present disclosures.

### ADVANTAGEOUS EFFECTS OF INVENTION

As described above, according to the embroidery design production management apparatus and method in accordance with the embodiments of the present disclosure, a delivery quantity and a delivery schedule for determining whether it is possible to obtain a placed order can be accurately predicted by a parametric estimating scheme instead of an analogous estimating scheme.

According to the embroidery design production management apparatus and method of the present disclosure, an order taker can easily take an order, associated with embroidery design production, from an order placer over a network. Also, the embroidery design production management apparatus and method of the present disclosure searches information of embroidery machines connected to the network based on placed order information to identify available embroidery machines, and calculates process productivity in a factory line which is configured by analyzing machine productivity for the identified available embroidery machines and combining the available embroidery machines, thereby obtaining the optimal process sequence. That is, the embroidery design production management apparatus and method of the present disclosure can predict a delivery schedule for the order quantity so as to enable a producer to check whether it is possible to obtain the production order of an order placer. Also, the embroidery design production management apparatus and method of the present disclosure provides an effective and quick solution to the error of an embroidery machine which occurs in producing embroidery design products according to the obtained optimal process sequence, thus enabling the producer to perform production management according to the order schedule of the order placer. Therefore, the producer can quickly and accurately determine whether it is possible to obtain the production order of the order placer, and thereby preventing a production problem which is caused in producing embroidery designs. The producer can obtain the production order of the order placer based on a productive capacity, and thus, smoothly manage an embroidery machine and users, thereby decreasing production burden and enhancing productivity in an embroidery design production process.

### BRIEF DESCRIPTION OF DRAWINGS

FIG. 1 is a diagram illustrating an embroidery design production management system to which embroidery design production management is applied, according to an embodiment of the present disclosure.

FIG. 2 is a block diagram illustrating an embroidery design production management apparatus according to an embodiment of the present disclosure.

FIG. 3 is a diagram illustrating an output screen for order information in association with an embodiment of the present disclosure.

FIG. 4 is a diagram illustrating an output screen for an embroidery design analysis result in association with an embodiment of the present disclosure.

FIG. 5 is a diagram illustrating an output screen for preparing a process simulation in association with an embodiment of the present disclosure.

FIG. 6 is a diagram illustrating an output screen for a process simulation result in association with an embodiment of the present disclosure.

FIG. 7 is a diagram illustrating an output screen for estimated profit and loss and the estimate cost per unit in association with an embodiment of the present disclosure.

FIG. 8 is a diagram illustrating an output screen for a current work status monitoring result in association with an embodiment of the present disclosure.

FIG. 9 is a diagram illustrating an output screen for work schedule management in association with an embodiment of the present disclosure.

FIG. 10 is a diagram illustrating an output screen for a productivity comparison analysis result in association with an embodiment of the present disclosure.

FIG. 11 is a diagram illustrating text data provided for repairing the abnormal state of an embroidery machine in association with an embodiment of the present disclosure.

FIG. 12 is a diagram illustrating multimedia data provided for repairing the abnormal state of an embroidery machine in association with an embodiment of the present disclosure.

FIG. 13 is a diagram illustrating an output screen for an after-sales service request result provided for repairing the abnormal state of an embroidery machine in association with an embodiment of the present disclosure.

FIG. 14 is a flowchart illustrating an embroidery design production management method according to an embodiment of the present disclosure.

FIG. 15 is a flowchart illustrating an error management method of FIG. 14.

FIG. 16 is a flowchart illustrating the number of workable designs for each head in association with an embodiment of the present disclosure.

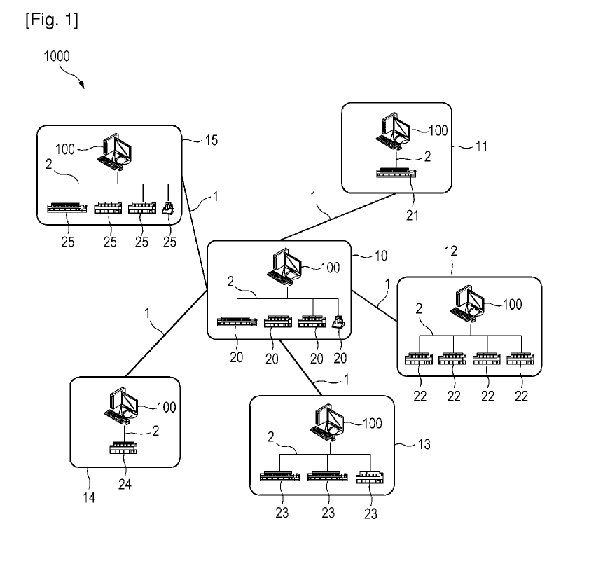

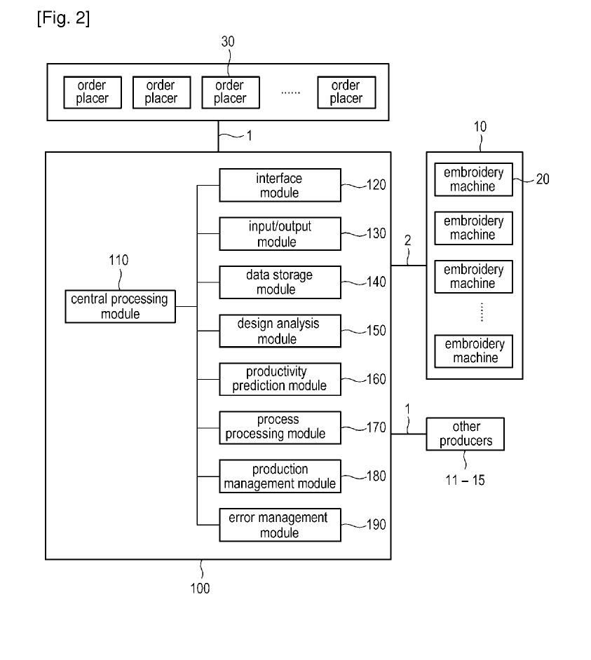

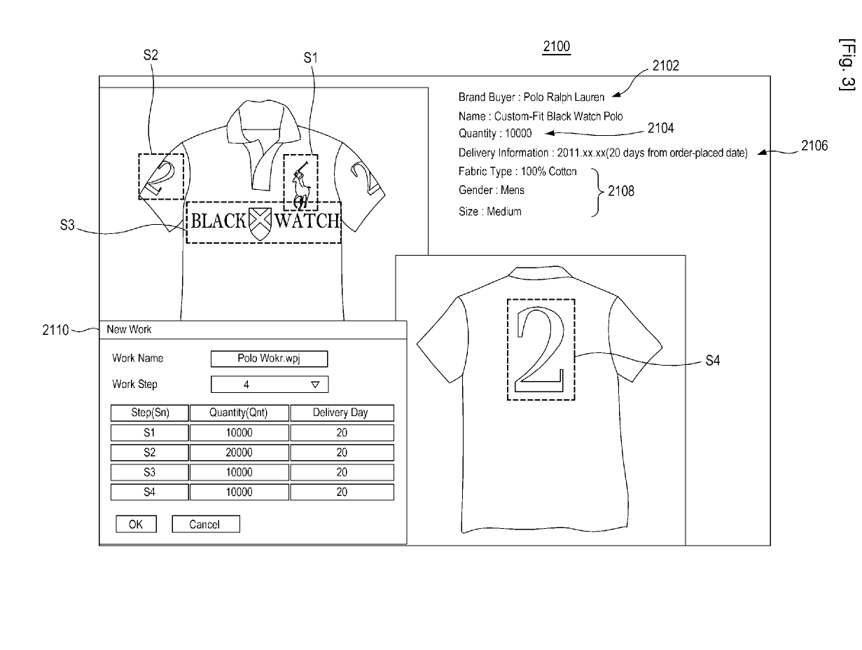

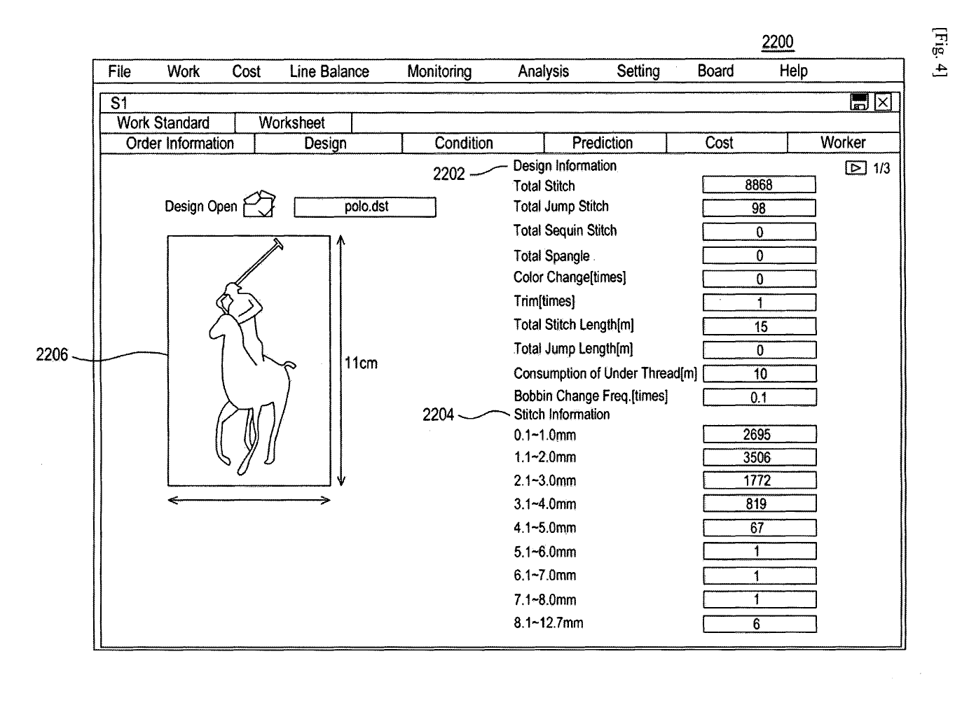

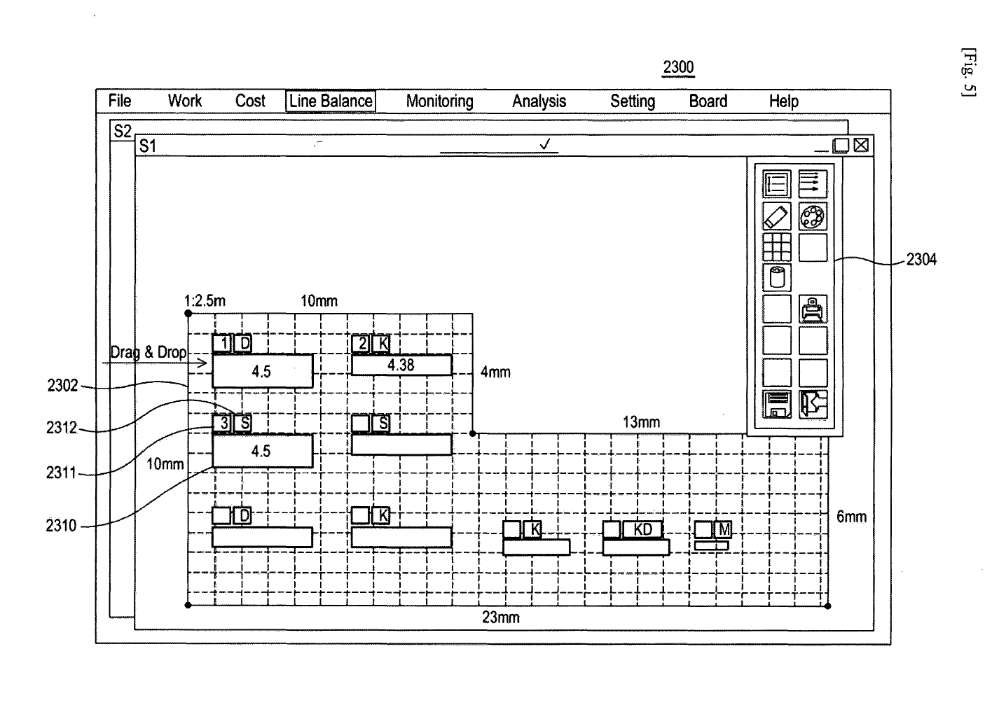

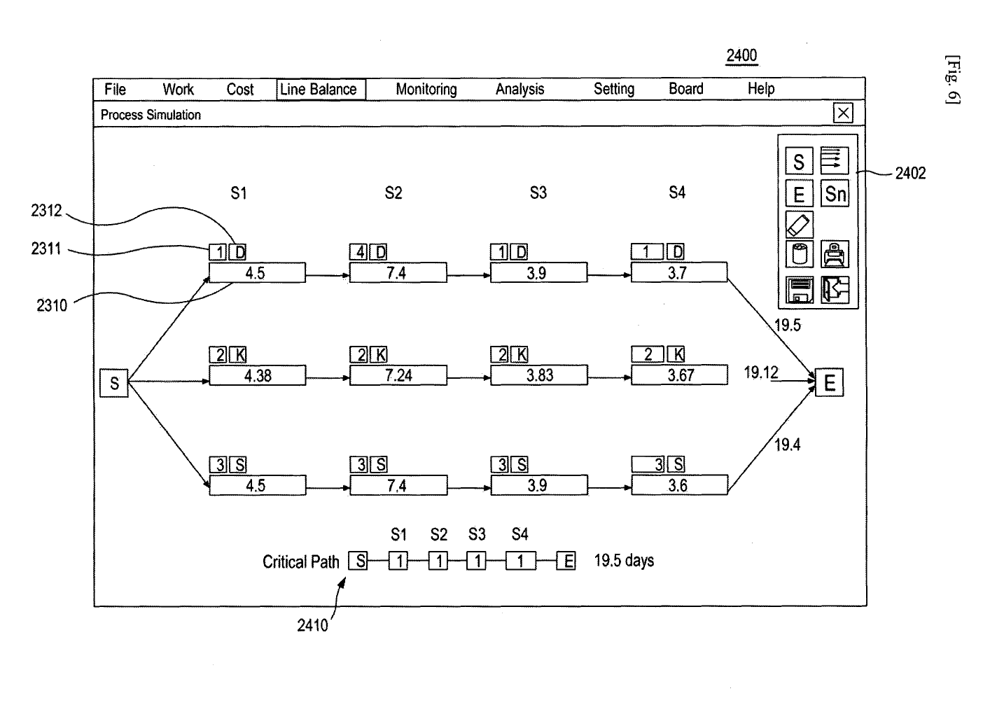

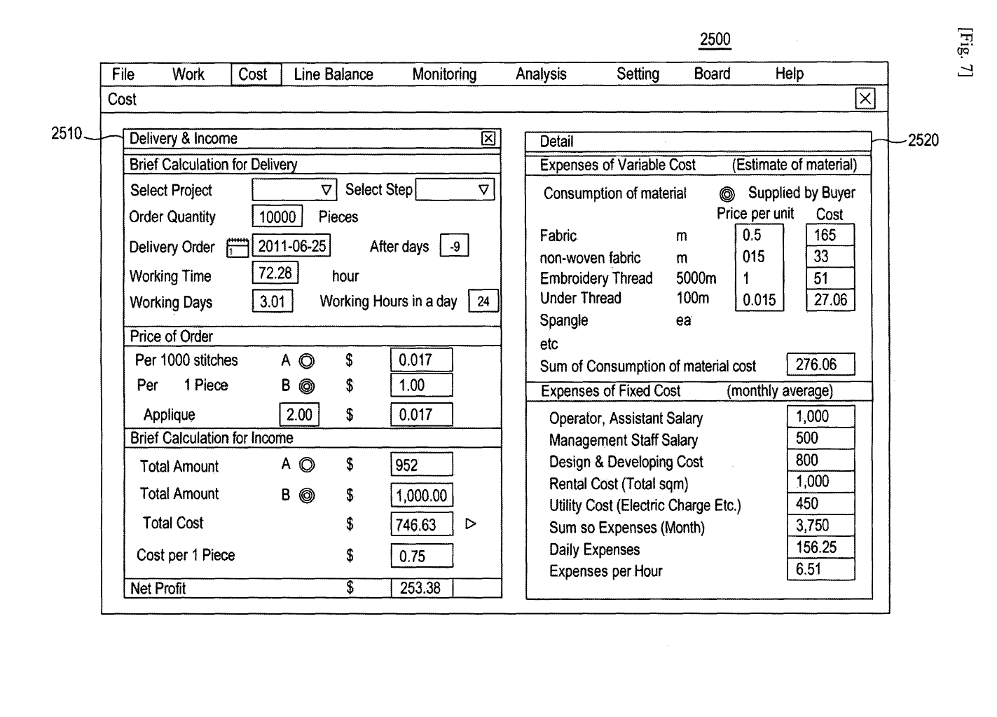

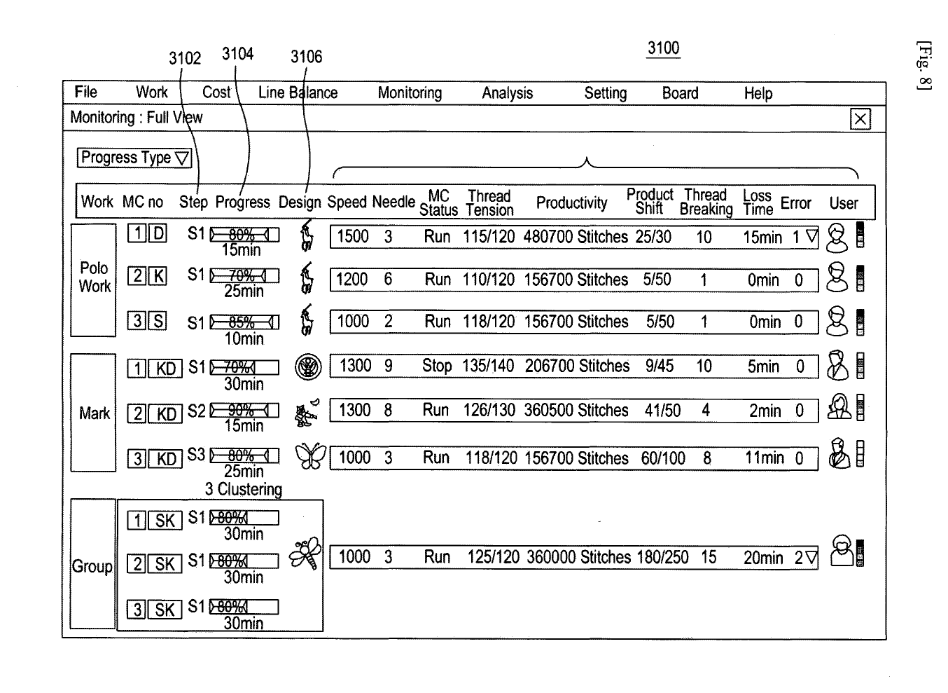

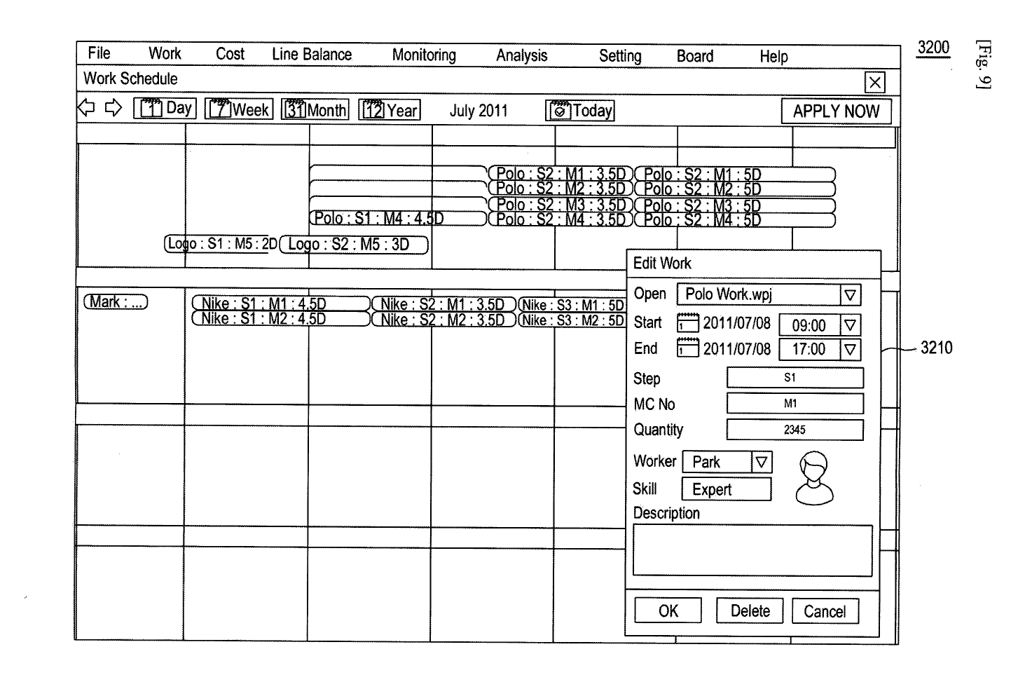

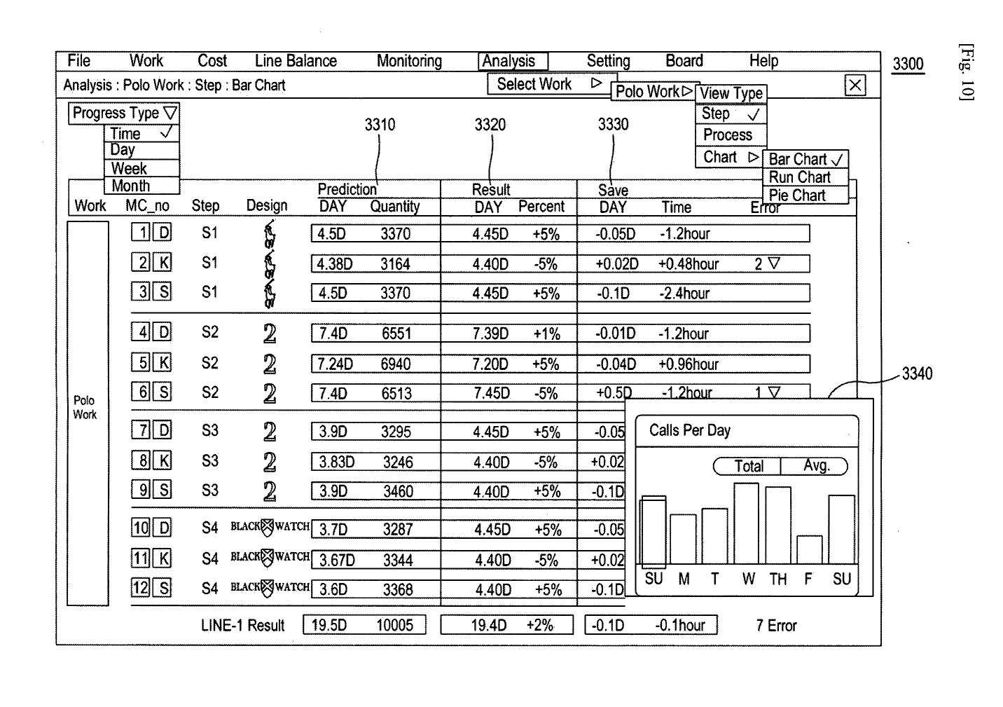

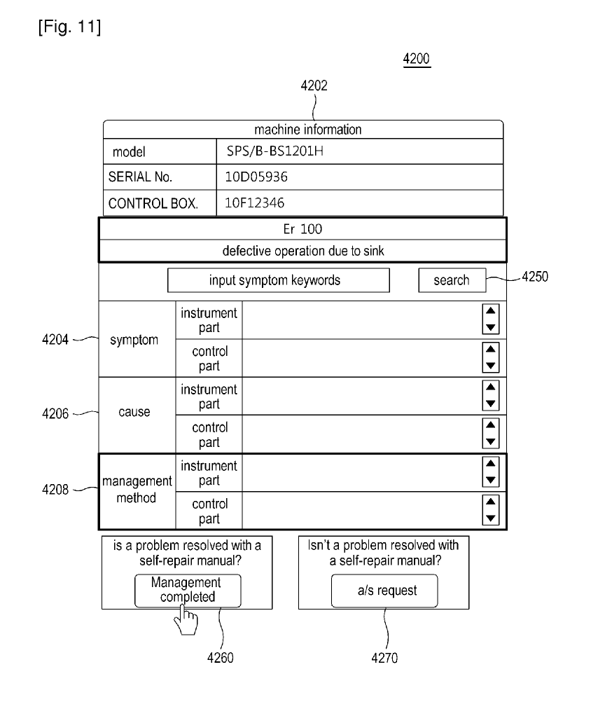

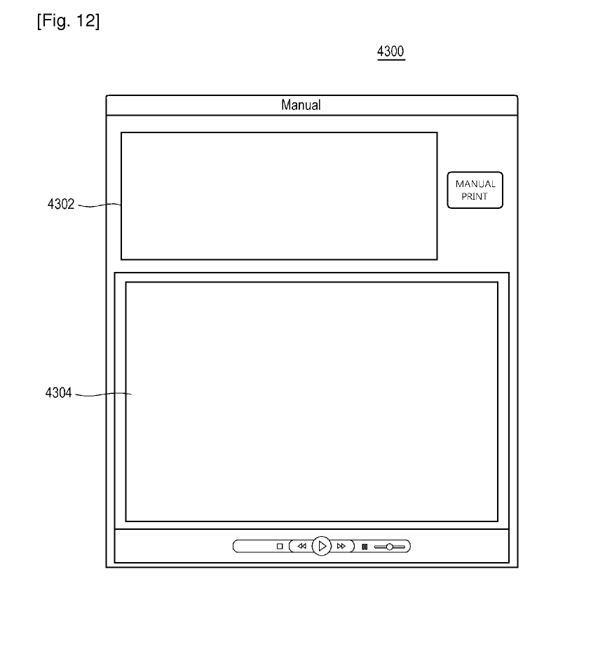

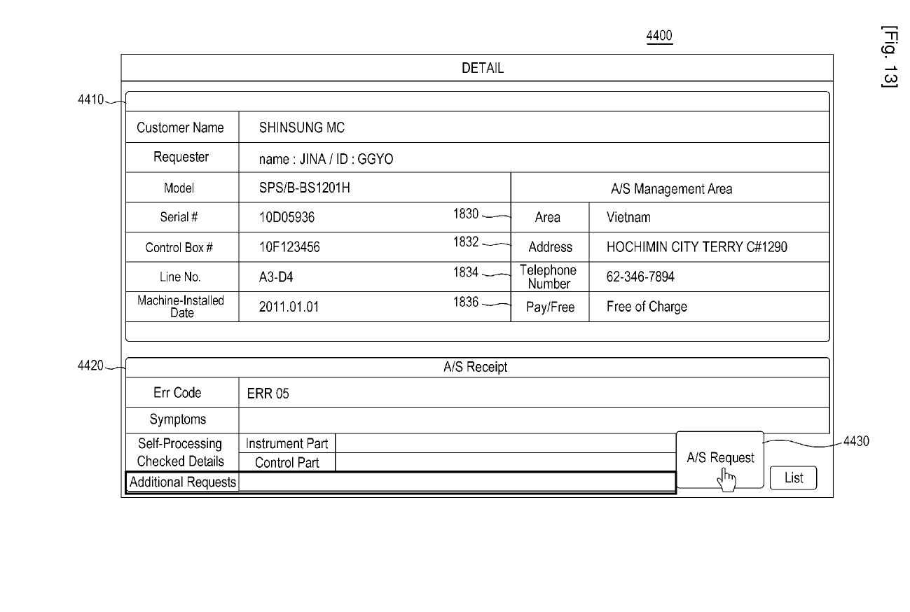

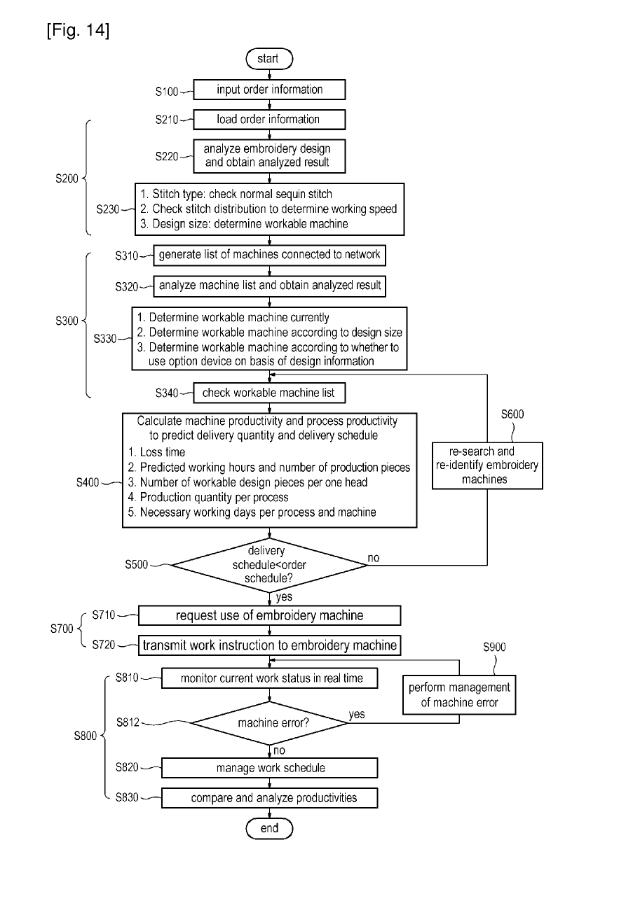

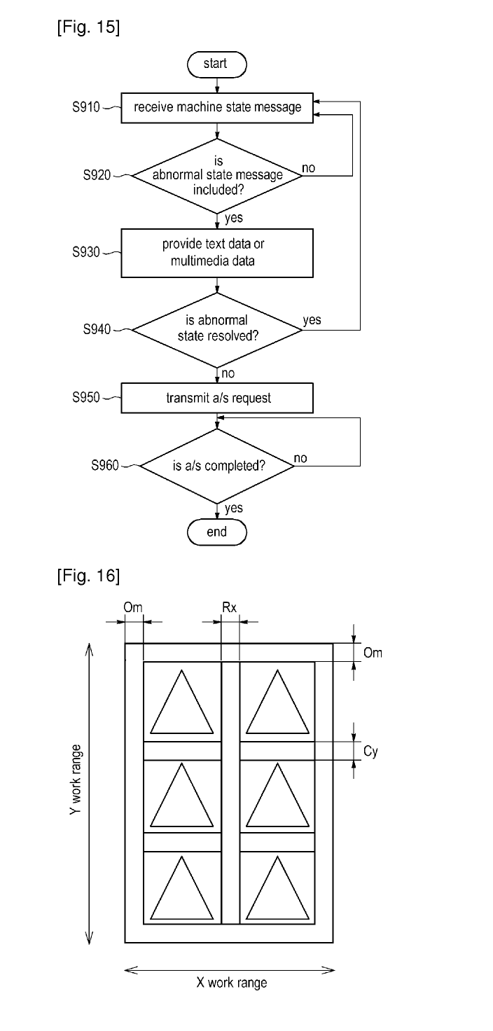

1. An embroidery design production management apparatus connected to a plurality of embroidery machines, comprising:
an interface module configured to connect an order placer and at least one producer over a network;
an input/output module configured to receive order information including an embroidery design from the order placer, receive a producer setting value from the producer, and output processing information for producing the embroidery design;
a data storage module configured to store information input or output via the input/output module;
a design analysis module configured to obtain design information and stitch information for the embroidery design; and
a productivity prediction module configured to search and identify available embroidery machines among the plurality of embroidery machines based on the design information, the stitch information, and the producer setting value, and calculate machine productivity for the identified available embroidery machines and process productivity in a plurality of factory lines to predict a delivery schedule for checking whether it is possible to obtain the order information, the plurality of factory lines being configured by combining the available embroidery machines.

2. The embroidery design production management apparatus of claim 1, further comprising a process processing module configured to transmit a work instruction, indicating a start of the embroidery design production, to the available embroidery machines.

3. The embroidery design production management apparatus of claim 2, further comprising a production management module configured to monitor a current work status in the embroidery design production in real time, manage a work schedule for the embroidery design production, and compare and analyze the predicted delivery schedule and an actual work schedule.

4. The embroidery design production management apparatus of claim 3, further comprising an error management module configured to receive machine state information from the available design machine, the machine state information comprising an abnormal state message that indicates an embroidery machine among the available embroidery machines being in an abnormal state.

5. The embroidery design production management apparatus of claim 4, wherein the error management module is configured to transmit at least one of text data and multimedia data, which are necessary for repairing the abnormal state, to a user based on the abnormal state message.

6. The embroidery design production management apparatus of claim 5, wherein the error management module is configured to provide an A/S request message to the producer in response to a request of the user.

7. The embroidery design production management apparatus of claim 6, wherein the error management module is configured to monitor an A/S providing state based on the A/S request message.

8. The embroidery design production management apparatus of claim 1, wherein the order information includes order placer information, an order quantity, and an order schedule.

9. The embroidery design production management apparatus of claim 1, wherein the producer setting value comprises a number of breakings of a thread, a loss time when the breaking of the thread occurs, a loss time in replacing one head, any other loss time, daily working hours, a work range of one head, design price, design margin, necessary working days, and the number of available embroidery machines.

10. The embroidery design production management apparatus of claim 9, wherein the productivity prediction module calculates a loss time, predicted working hours and number of production pieces, a number of workable design pieces per one head, production quantities per process, necessary working days per machine, and a number of necessary users per process for calculating the machine productivity and the process productivity.

11. The embroidery design production management apparatus of claim 1, wherein the design information includes a total number of needles of the embroidery design, an entire needle length of an upper thread, a number of replacements of a bobbin, and a design size, and the stitch information includes a stitch width of the embroidery design.

12. The embroidery design production management apparatus of claim 1, wherein the productivity prediction module is configured to calculate working days necessary for a critical path in the plurality of factory lines, and calculates an estimated profit and loss and an estimate cost per unit.

13. An embroidery design production management method, comprising:
receiving order information comprising an embroidery design from an order placer and receiving a producer setting value from a producer, over a network;
analyzing the embroidery design;
searching and identifying available embroidery machines among a plurality of embroidery machines connected to the network, according to the analyzed result of the embroidery design and the producer setting value;
calculating machine productivity for the identified available embroidery machines and process productivity in a plurality of factory lines that are configured by combining the available embroidery machines;
predicting a delivery schedule for an order quantity for the order information based on the calculated machine productivity and the calculated process productivity, and comparing the predicted delivery schedule and an order schedule for the order information; and
re-searching and re-identifying the plurality of embroidery machines connected to the network and an embroidery machine, which is additionally set by the producer, until the delivery schedule satisfies the order schedule, and repeatedly performing the calculating machine productivity and process productivity for a re-identified available embroidery machine and the comparing the predicted delivery schedule and the order schedule.

14. The embroidery design production management method of claim 13, further comprising transmitting a work instruction to the available embroidery machines to start the embroidery design production when the delivery schedule satisfies the order schedule, after the comparing the predicted delivery schedule and an order schedule.

15. The embroidery design production management method of claim 14, further comprising:
monitoring a current work status on the available embroidery machines in real time;
managing a work schedule for the available embroidery machines; and
comparing and analyzing the predicted delivery schedule and an actual work schedule.

16. The embroidery design production management method of claim 15, wherein the monitoring a current work status includes receiving a machine state information from the available embroidery machines, and the machine state information includes an abnormal state message that indicates at least one available embroidery machine among the available embroidery machines being in an abnormal state.

17. The embroidery design production management method of claim 16, further comprising transmitting at least one of text data and multimedia data, which are necessary for repairing the abnormal state, to a user based on the abnormal state message.

18. The embroidery design production management method of claim 17, further comprising sending an A/S request message to the producer in response to a request of the user.

19. The embroidery design production management method of claim 18, further comprising monitoring an A/S providing state for the at least one available embroidery machine based on the A/S request message.

20. The embroidery design production management method of claim 13, wherein the calculating machine productivity and process productivity includes calculating a loss time, predicted working hours and number of production pieces, a number of workable design pieces per one head, production quantities per process, necessary working days per machine, and a number of necessary users per process.

21. The embroidery design production management method of claim 20, wherein the loss time is calculated with the following Equation (1);
(total loss time[min]in producing one piece)=(loss time[min]in breaking of thread)+(loss time[min]in replacing bobbin)+(other loss time[min]) (1)
where(loss time[min]in breaking of thread)=(number of breakings of thread×loss time[sec]when breaking of thread occurs)/60,(loss time [min]in replacing bobbin)=(number of replacements of bobbin×total number of heads×loss time[sec]in replacing one head)/60,(number of replacements of bobbin)=(quantity[meter]of consumed bottom thread)/100 when general shuttle,(number of replacements of bobbin)=(quantity[meter]of consumed bottom thread)/150 when large shuttle,(quantity[meter]of consumed bottom thread)=(entire needle length of upper thread)×⅔,
where the number of breakings of thread, the loss time when breaking of thread occurs, the loss time in replacing one head, the number of heads based on number of available embroidery machines, and the other loss time comprising a piece replacement time are input as a plurality of producer setting values, and the entire needle length of upper thread and the number of replacements of bobbin are calculated in an embroidery design analysis operation.

22. The embroidery design production management method of claim 21, wherein the predicted working hours and the number of production pieces are calculated with the following Equations (2) and (3);
(predicted time[min]in producing one design)=Sum(RPM_TABLE[M][S]+RPM_TABLE[M][S]+RPM_TABLE[M][S]+ . . . ) (2)
where [M] denotes the type of an embroidery machine, [S] denotes a stitch length, and RPM_TABLE[M][S] denotes a defined time for the needle length of a selected embroidery machine,
(number[times]of production pieces per daily working hours)=(daily working hours[hour]×60 [min])/(predicted time[min]in producing one design+total loss time[min]in producing one piece) (3)
where daily working hours are input as a producer setting value, predicted time in producing one design is calculated with the Equation (2), and total loss time in producing one piece is calculated with the Equation (1).

23. The embroidery design production management method of claim 22, wherein the number of workable design pieces per one head is calculated with the following Equation (4);
(number of workable design pieces per one head)=Rxcnt×Cycnt (4)
where Cycnt denotes number of embroidery designs comprised within a range in which a column interval between embroidery designs and upper and lower outline margins are excluded within a vertical work range, and Rxcnt denotes number of embroidery designs comprised within a range in which a row interval between embroidery designs and left and right outline margins are excluded within a horizontal work range.

24. The embroidery design production management method of claim 23, wherein the production quantities per process and necessary working days per machine are calculated with the following Equations (5) and (6);
(production quantities per process)=(number[times]of production pieces per daily working hours)×(number[times]of workable design pieces per one head)×(number of heads)×(necessary working days by embroidery machine) (5)
(necessary working days per machine)=(production quantities per process/N)/(number[times]of production pieces per daily working hours×number of workable design pieces per one head×number of heads) (6)
where the number of production pieces per daily working hours is calculated with Equation (3), the number of workable design pieces per one head is calculated with Equation (4), the number of heads is input as a producer setting value, and N denotes the number of selected embroidery machines.

25. The embroidery design production management method of claim 24, wherein the number of necessary users per process is calculated with the following Equation (7);
(number of necessary users per process)=(sum of heads per process machine/number of basic heads per user×daily working hours[hour]/(basic working hours per user) (7)
where the sum of heads per process machine is automatically calculated in selecting an embroidery machine, and the number of basic heads per user, the daily working hours, and the basic working hours per user are input as a plurality of producer setting values.

26. The embroidery design production management method of claim 13, wherein the calculating the process productivity in a plurality of factory lines includes obtaining a critical path in the plurality of factory lines.
